(19) United States
(12) Patent Application Publication
(10) Pub. No.: US 2026/0187998 A1
(43) Pub. Date: Jul. 2, 2026

(54) PROCESSING APPARATUS FOR ACCELERATING CONVOLUTION OPERATIONS AND METHOD OF OPERATING THE SAME

(71) Applicant: SEOUL NATIONAL UNIVERSITY R&DB FOUNDATION, Seoul (KR)

(72) Inventors: Jae-Joon KIM, Seoul (KR); Jihoon PARK, Seoul (KR)

(21) Appl. No.: 19/435,980

(22) Filed: Dec. 30, 2025

(30) Foreign Application Priority Data
Dec. 31, 2024 (KR) 10-2024-0202599
Dec. 9, 2025 (KR) 10-2025-0193780

(51) Int. Cl. G06V 10/94; G06T 1/60; G06V 10/77; G06V 10/82

(52) U.S. Cl. CPC G06V 10/955; G06T 1/60; G06V 10/7715; G06V 10/82

(57) ABSTRACT

A processing apparatus for accelerating convolution operations according to one embodiment includes a plurality of elementary processing unit arranged in an array structure, a line buffer in which data is temporarily stored, and a controller configured to control operations of the line buffer and the elementary processing unitelementary processing units to perform convolution operations. The controller stores a portion of feature-map data in the line buffer for the convolution operation, performs convolution operations on the portion of feature-map data stored in the line buffer and kernel data stored in the elementary processing unit, and divides a feature map to be processed during the convolution operation into a plurality of partitions in consideration of a storage capacity of the line buffer and a size of the feature map, and stores, in the line buffer, data among the divided feature-map data to be operated with the kernel data.

### CROSS-REFERENCE TO RELATED APPLICATION

This application is based on and claims priority under 35 U.S.C. § 119 to Korean Patent Application No. 10-2025-0193780, filed on Dec. 9, 2025, in the Korean Intellectual Property Office and to Korean Patent Application No. 10-2024-0202599, filed on Dec. 31, 2024, in the Korean Intellectual Property Office, the disclosure of which is incorporated by reference herein in its entirety.

### BACKGROUND

### Technical Field

The present invention relates to a processing apparatus for accelerating convolution operations and a method of operating the same.

### Background Art

A convolution operation is an operation mainly used in image processing and a convolution neural network (CNN). In the convolution operation, a kernel (or filter) is overlaid on a specific region of input data (an image), and multiplication-and-addition operations are performed to extract features. The kernel is generally a small matrix such as a 3×3 or 5×5 matrix and performs various functions such as edge detection, blurring, and feature-map extraction. After applying the kernel at one location of the input data or a feature map output from a previous convolution layer and performing the operation, the kernel is moved by one stride and repeatedly applied to the entire region so that a feature map is generated as an output.

To efficiently perform convolution in a hardware accelerator configured to perform convolution operations, the same pixel must be reusable without being read multiple times. For this purpose, conventional technology is known in which a line buffer is used to store several consecutive rows of an input image in memory and supply a data window having the size of the kernel at every clock cycle.

For example, in the case of a 3×3 kernel, the line buffer maintains at least two rows and receives one new row to form a sliding window. Due to such a structure, access to a main memory (for example, a DRAM) can be reduced, and real-time streaming operations can be performed in a pipelined CNN accelerator. That is, unlike a layer-by-layer execution method in which the result of each layer operation is stored in the main memory and then read again, a layer-pipeline structure is enabled in which the output of each layer is directly delivered to the next layer. As a result, access to the main memory can be significantly reduced, and data can flow continuously inside the CNN accelerator like streaming, thereby enabling real-time pipelined operations.

FIG. 1 is a diagram illustrating a convolution operation using a line buffer in a typical conventional technology.

FIG. 1 illustrates entire input data to be subjected to convolution operations and a configuration of a kernel. The kernel is a 3×3 kernel, and convolution operations are performed while the kernel strides to the right. When convolution operations for each row are completed, the kernel moves to the data of the leftmost coordinate of the next row and then strides to the right again.

At this time, several consecutive rows of input data on which convolution operations will be performed are stored in advance in the line buffer.

For example, a size of the line buffer may be determined according to the following Mathematical Expression.

$${L}_{i} = ( {W}_{i} * ( {kH}_{i} - 1 ) + {kW}_{i} ) * {C}_{in , i} {L}_{ti} = {\sum }_{i} {L}_{i} \qquad [ Mathematical Expression 1 ]$$

In this case, Wi denotes a width of an input feature map, Hi denotes a height of the input feature map, Cin,i denotes a number of input channels, and kHi and kWi respectively denote a vertical size and a horizontal size of a kernel.

If the kernel height is kH, at least kH−1 rows of the input feature map must be stored in advance to form a kernel window together with a next row, and when including a row currently being processed, a total of kH rows may be required simultaneously. Accordingly, a size of the line buffer may be calculated by multiplying the total number of pixels in the horizontal direction (Wi) by the number of channels (Cin,i).

As described above, in the conventional technology, a final line buffer capacity is obtained by summing buffer sizes required for each layer (i). Accordingly, a capacity of the line buffer is determined in proportion to a width of an input feature map for each layer. As a result, a memory requirement of the line buffer tends to increase linearly as a horizontal size of the input feature map increases, and when the memory requirement of the line buffer exceeds an allocatable buffer size of hardware, a problem may occur in which the corresponding feature map cannot be processed.

The present invention proposes a new processing apparatus capable of solving such technical problems of the conventional art.

### SUMMARY

### Technical Problem

The present invention aims to solve the problems of the conventional technology described above by proposing a processing apparatus and an operating method capable of performing convolution operations by dividing a feature map into a plurality of partitions.

However, the technical problem to be achieved by the present embodiment is not limited to the technical problems described above, and other technical problems may also exist.

### Means for Solving the Problem

As a technical means for achieving the above-described technical problems, a processing apparatus for accelerating convolution operations according to a first aspect of the present invention includes a plurality of elementary processing unit arranged in an array structure; a line buffer in which data is temporarily stored; and a controller configured to control operations of the line buffer and the elementary processing unit to perform convolution operations. In this case, the controller stores a portion of data of a feature map in the line buffer for convolution operations, performs convolution operations on a portion of feature-map data stored in the line buffer and kernel data stored in the elementary processing unit, divides the feature map to be processed during the convolution operations into a plurality of partitions in consideration of a storage capacity of the line buffer and a size of the feature map, and stores, in the line buffer, data among the divided feature-map data that is to be operated with the kernel data.

In addition, an operating method of a processing apparatus for accelerating convolution operations according to a second aspect of the present invention includes dividing a feature map on which convolution operations are to be performed into a plurality of partitions; storing, in a line buffer, data among the divided feature-map data that is to be operated with kernel data; and performing convolution operations on a portion of feature-map data stored in the line buffer and the kernel data stored in elementary processing unit included in the processing apparatus.

### Effects of the Invention

According to the configuration of the present invention, by dividing a feature map, which is to be subjected to convolution operations, in a width direction, a required capacity of a line buffer can be reduced. In particular, in the conventional technology, the required capacity of a line buffer tends to increase linearly as the size of a feature map increases. However, according to the present invention, such a required capacity of the line buffer can be reduced. As a result, a memory capacity required in hardware is reduced, and convolution operations become possible even for larger feature maps.

In addition, according to the configuration of the present invention, since each divided partition has an overlapping portion with another partition, pixels are processed continuously without being omitted at each stage. Such a structure prevents data loss that may occur in convolution operations.

In addition, the present invention provides flexibility to adapt to various hardware environments by adjusting a size of a feature map and the number of divisions. This provides an opportunity to maximize efficiency of in-memory computing in various applications and allows flexible response to requirements that arise with future technological advancements.

In addition, as a required capacity of the line buffer is reduced, a hardware design of an entire system can be made lighter. This reduces manufacturing costs and decreases power consumption of the system, thereby enabling an environmentally friendly design.

### BRIEF DESCRIPTION OF THE DRAWINGS

FIG. 1 is a diagram illustrating a convolution operation using a line buffer in a typical conventional technology.

FIG. 2 illustrates a processing apparatus according to an embodiment of the present invention.

FIG. 3 and FIG. 4 illustrate feature-map data stored in a line buffer and divided into a plurality of partitions according to an embodiment of the present invention.

FIG. 5 is a diagram illustrating an operation performed by a controller of a processing apparatus according to an embodiment of the present invention.

FIG. 6 illustrates an operating method of a processing apparatus according to an embodiment of the present invention.

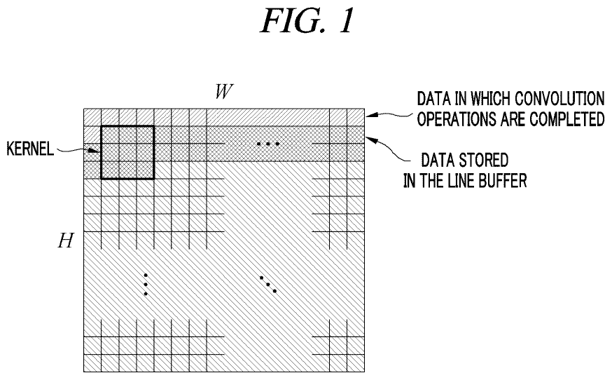

### DETAILED DESCRIPTION OF THE INVENTION

The embodiments of the present invention will be described in detail below with reference to the accompanying drawings so that those skilled in the art to which the present invention pertains can easily carry out the invention. However, the present invention may be implemented in various different forms and is not limited to the embodiments described herein. In addition, for clarity of description, parts not related to the explanation of the invention are omitted in the drawings, and like reference numerals designate like elements throughout the specification.

Throughout the specification, when a part is described as being “connected” to another part, this includes not only cases in which the parts are “directly connected,” but also cases in which other components are interposed therebetween and the parts are “electrically connected.” In addition, when a part is described as “including” a component, this means that the part may further include other components unless specifically stated otherwise.

Throughout the present specification, when a member is described as being “on” another member, this includes cases in which the member is in contact with the other member as well as cases in which another member exists between the two.

Hereinafter, preferred embodiments of the present invention will be described in detail with reference to the accompanying drawings and the content described below. However, the present invention is not limited to the embodiments described herein and may be embodied in various other forms. Identical reference numerals throughout the specification denote identical components.

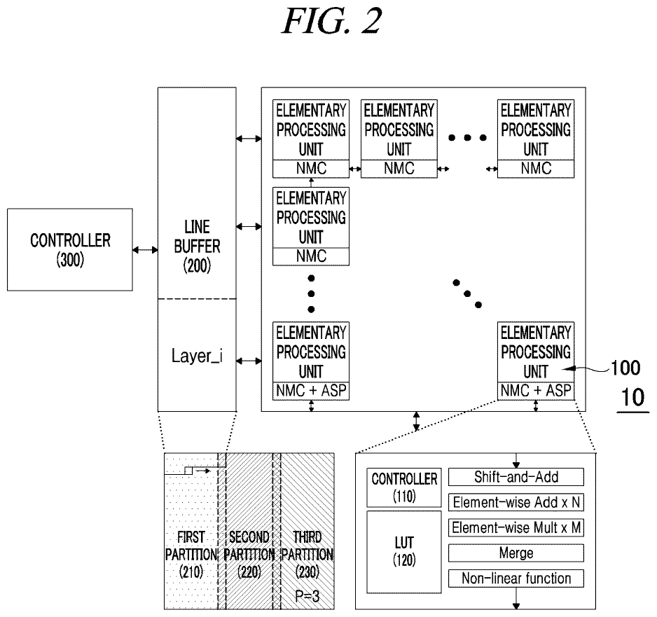

FIG. 2 illustrates a processing apparatus according to an embodiment of the present invention.

A processing apparatus (10) for accelerating convolution operations includes a plurality of elementary processing unit (100) arranged in an array structure; a line buffer (200) in which data is temporarily stored; and a controller (300) configured to control operations of the line buffer (200) and the elementary processing unit (100) to perform convolution operations.

The elementary processing unit (100) may be implemented in the form of a CIM (computing-in-memory) unit or a PE (processing element) unit. The elementary processing unit (100) has a structure in which data storage and arithmetic operations on data are performed simultaneously. For example, a CIM unit is implemented in SRAM, DRAM, or nonvolatile memories arranged in an array structure, primarily storing the weight data. The CIM unit mainly performs multiply-accumulate (MAC) operations on input data and weight data. Operations are performed at each memory-cell level, input data is applied through word lines, and a result of the multiplication of the input data and the weight data is output as a current flowing through bit lines. Since the bit-line current represents an accumulated value of multiplication results from multiple cells, the MAC operation is naturally performed. In addition, a elementary processing unit (100) using a CIM unit may include peripheral circuitry such as an analog-to-digital converter (ADC) configured to convert analog currents into digital values; a shift-and-add circuit; element-wise arithmetic circuits (element-wise add/mult); merge operation circuits; and logic for nonlinear functions such as activation functions (e.g., ReLU, sigmoid, tanh). The shift-and-add circuit performs basic weight operations or scaling adjustments by combining shift operations (bit shifts) with addition operations on input values. The element-wise arithmetic circuit repeats addition or multiplication operations between corresponding elements of multiple input vectors or matrices, thereby applying repeated element-wise addition or multiplication to data of the same dimension. A look-up table (LUT) may be used to process nonlinear functions (ReLU, sigmoid, tanh), normalization, bit operations, and similar operations at high speed in hardware. A controller (110) may manage memory access, operation sequencing, LUT reference (120), and other control functions for each elementary processing unit (100). Meanwhile, since the detailed configuration of the elementary processing unit (100) using a CIM unit substantially corresponds to conventional technology, a detailed description thereof will be omitted.

Meanwhile, the PE unit is a conventional operation unit used in typical CNN accelerators, reads weight data or kernel data from an external memory or buffer, and performs CNN operations on feature-map data stored in the line buffer (200).

The controller (300) stores a portion of feature-map data in the line buffer (200) for convolution operations and controls the elementary processing unit (100) to perform convolution operations on a portion of feature-map data stored in the line buffer (200) and kernel data. In this case, the kernel data corresponds to weight data stored in the elementary processing unit (100). The controller (300) divides a feature map processed during convolution operations into a plurality of partitions in consideration of a storage capacity of the line buffer (200) and a size of the feature map, and stores, in the line buffer (200), data among the divided feature-map data that is to be operated with the kernel data. As illustrated, entire input data or a feature map may be divided into a first partition (210), a second partition (220), and a third partition (230). Although three partitions are illustrated as an example in the drawings, division into two partitions or into four or more partitions is also possible.

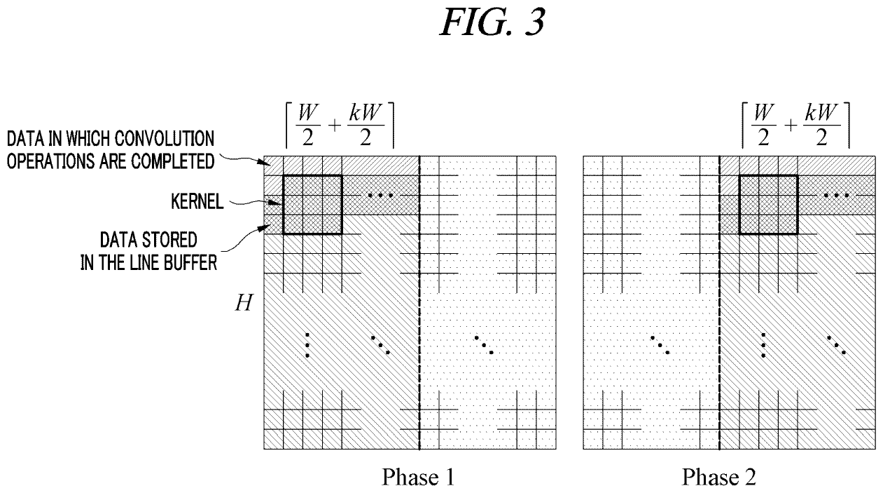

FIG. 3 illustrates a form in which a feature map stored in the line buffer (200) is divided into a plurality of partitions according to an embodiment of the present invention.

A feature map may be divided along an axis in a horizontal direction (W), thereby enabling convolution operations even for larger feature maps. As described above, a position of a kernel for convolution operations strides in a rightward direction, and feature-map data for which convolution operations are completed is temporarily stored in the line buffer (200), representing elements that have been pushed out, while data stored in the line buffer represents data to be subjected to convolution operations through the kernel.

As the feature map is divided into partitions, the line buffer may operate by being divided into phases corresponding to the number of partitions (P). In a first phase, a portion of the first partition of the feature map is used for computation, and in a second phase, a portion of the remaining feature map (or a second partition) is used for computation. The two phases are completely separated in time, enabling the same line buffer (200) to be used. As such, the divisions of the feature map are referred to as respective partitions, and a process in which convolution operations are performed for each partition is defined as a phase. In the present invention, convolution operations are independently performed for each partition, and therefore phases different from one another are set for the respective partitions.

A feature map may be divided along the axis in the W direction, and a width of each partition is defined as shown in Mathematical Expression 2.

$${W}^{′} = ⌈ \frac{W + 2 ( P - 1 ) ⌊ kW / 2 ⌋}{P} ⌉ \qquad [ Mathematical Expression 2 ]$$

That is, it is determined by a term

$$⌈ \frac{2 ( P - 1 ) ⌊ kW / 2 ⌋}{P} ⌉$$

corrected by the value obtained by dividing the entire width (W) of the feature map by the number of partitions and the kernel width (kW).

In addition, a starting index in the W direction of the p-th partition is defined as shown in Mathematical Expression 3.

$$⌈ {W}^{′} ⌉ * p - ⌊ \frac{kW}{2} ⌋ * ( p + 1 ) \qquad [ Mathematical Expression 3 ]$$

In this manner, each partition includes an overlapping portion of

$$2 * ⌊ \frac{kW}{2} ⌋ ,$$

thereby preventing any pixel from being omitted when the convolution operation is performed.

When the entire feature map is assumed to be divided into a plurality of partitions, convolution operations may be sequentially performed while storing a portion of the feature map for each partition in the line buffer, and a convolution-operation result for the entire feature map may be output by simply merging convolution results for the respective partitions. That is, when the entire feature map is assumed to be divided into two partitions (that is, a first partition and a second partition), a convolution operation for the second partition is performed after completion of the convolution operation for the first partition, and a simple merge of the convolution-operation result for the first partition and the convolution-operation result for the second partition which is identical to the output of the convolution operation for the entire feature map.

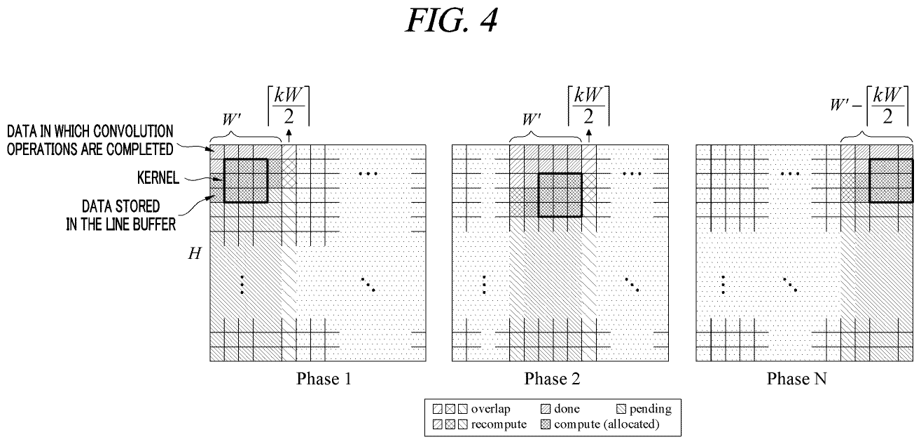

FIG. 4 illustrates a form in which a feature map stored in the line buffer (200) is divided into a plurality of partitions according to an embodiment of the present invention.

The embodiment of FIG. 3 is identical in its main operations; however, unlike the embodiment of FIG. 3, an embodiment in which the feature map is divided into three partitions is illustrated. In addition, the overlapping portions of each partition by

$$2 * ⌊ \frac{kW}{2} ⌋$$

are clearly illustrated so that the overlap can be visually confirmed.

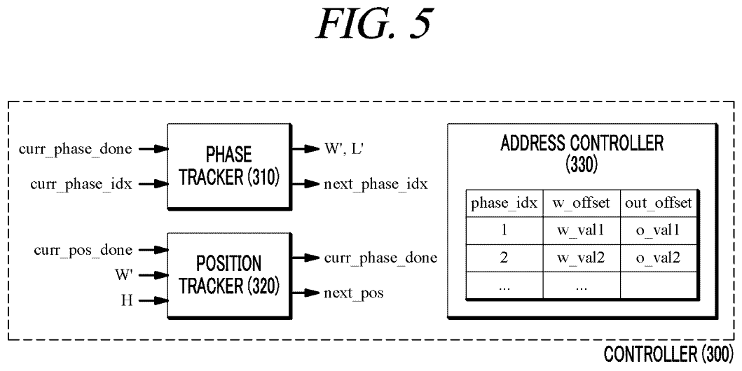

FIG. 5 is a diagram for explaining operations performed by a controller of a processing apparatus according to an embodiment of the present invention.

The controller (300) controls operations such as allocation of the line buffer (200) and partition-division operations. To this end, the controller includes a phase tracker (310) configured to track a phase in which a convolution operation is performed; a position tracker (320) configured to track a position of a coordinate at which the convolution operation is performed; and an address controller (330) configured to manage address information determined based on tracking results of the phase and coordinate position.

The phase tracker (310) calculates a width W′ of each partition according to Mathematical Expression 2 described above. In addition, the phase tracker (310) calculates a line-buffer length L′ for each partition. For example, when the stride and padding of the kernel are 0 and 1, respectively, a length of the line buffer before partitioning is Lⁱ=Wⁱ·(kHⁱ−1)+kWⁱ, whereas a length of the line buffer divided into P partitions may be defined as shown in Mathematical Expression 4.

$${L}_{i} = ⌈ \frac{{W}^{i} + 2 ( P - 1 ) ⌊ {kW}^{i} / 2 ⌋}{P} ⌉ \cdot ( {kH}^{i} - 1 ) + {kW}^{i} \qquad [ Mathematical Expression 4 ]$$

L denotes a capacity of the line buffer, W denotes a width of the feature map, kW denotes a width of the kernel, kH denotes a height of the kernel, P denotes a number of partitions, and i denotes a layer.

In addition, the phase tracker (310) outputs an identifier next_phase_idx of a next phase in which a convolution operation is to be performed, based on information curr_phase_idx indicating a phase in which the current convolution operation is being performed and a signal curr_phase_done indicating that a convolution operation for the corresponding partition or phase has been completed.

For example, as shown in FIG. 3, when a feature map is divided into a first partition and a second partition, and a phase-1 operation in which convolution operations for the first partition are performed is executed, the controller (300) calculates a width W′ of the partition based on Mathematical Expression 2 and calculates a kernel position curr_position within the corresponding partition. The phase tracker (310) initializes an identifier of a current partition or phase in which the kernel is located and in which the convolution operation is performed as 1. When a signal curr_phase_done indicating that the convolution operation for the corresponding partition or phase has been completed is input, the phase tracker (310) recognizes that the convolution operation for phase 1 has been completed and outputs phase 2 as next_phase_idx, which is an identifier of a next phase in which the convolution operation is to be performed. Then, based on Mathematical Expression 2, the controller calculates a value of the width W′ of the second partition to be used in the line buffer (200) and the memory capacity (proportion to) to be allocated to the line buffer.

The position tracker (320) tracks a position of a coordinate of the feature map on which the convolution operation is performed. Specifically, the position tracker (320) receives a height H of the feature map (which remains constant across phases), widths W′ of the respective partitions received from the phase tracker (310), and information curr_phase_done indicating whether a convolution operation for a current coordinate of the line buffer (200) has been completed, and updates a next execution coordinate. When the current coordinate reaches a final coordinate (W′, H), the position tracker (320) outputs a signal curr_phase_done indicating that the convolution operation for the corresponding phase has been completed.

With respect to an operation state of the address controller (330), the address controller (330) manages a table that stores a width offset w_offset and an output-width offset out_offset for each phase identifier phase_idx and calculates input and output addresses. In the case of the width offset w_offset, a start point of partition division is stored, and a portion of the feature map for a new phase that must overlap a previous feature map is reflected through the width offset. Address calculation performed by the address controller (330) may vary depending on a memory layout of the accelerator.

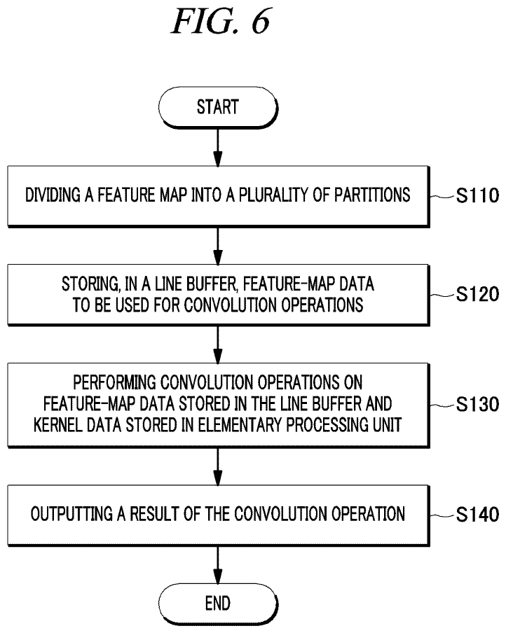

FIG. 6 illustrates a method of operating a processing apparatus according to an embodiment of the present invention.

A controller (300) of the processing apparatus (10) divides a feature map on which convolution operations are to be performed into a plurality of partitions (S110). As described above with reference to Mathematical Expression 2, a value corresponding to a sum of a value obtained by dividing an entire width W of the feature map by a number of partitions and a correction value based on a kernel width kW may be calculated as a width of each partition.

Next, data among the divided feature-map data that is to be convolution operated with kernel data is stored in the line buffer (200) (S120). In this case, a size of the line buffer (200) may be defined as shown in Mathematical Expression 4.

Next, convolution operations are performed on a portion of feature-map data stored in the line buffer (200) and kernel data stored in the elementary processing unit (100) (S130).

As convolution operations are performed, data of the feature map that is to be additionally included in the convolution operation is added to the line buffer (200) if the data is not already stored in the line buffer (200), and data stored in the line buffer (200) is included in the convolution operation. Meanwhile, a portion of data of the feature map that is to be excluded from the convolution operation is deleted from the line buffer (200). As illustrated in FIG. 3, data located at coordinates corresponding to the kernel among data stored in the line buffer (200) is removed from the line buffer (200) when convolution operations for the corresponding location are completed, and as the kernel is strided, data of the feature map that was outside the line buffer (200) is sequentially stored in the line buffer (200).

In the present invention, convolution operations are performed in different phases for respective feature maps divided into a plurality of partitions, and convolution results for the respective partitions are simply merged and output as convolution-operation results for the entire feature map. For example, when a feature map is divided into a first partition and a second partition, convolution operations for feature-map data of the first partition are performed in a first phase, convolution operations for feature-map data of the second partition are performed in a second phase, and convolution results from the first phase and the second phase are merged and output.

In this manner, convolution-operation results independently performed in respective phases for multiple partitions are merged and output as a final convolution-operation result (S140).

The embodiment of the present invention may also be implemented in the form of a non-transitory computer-readable medium including computer-executable instructions, such as a program module executed by a computer. A computer-readable medium may be any available medium that can be accessed by a computer and includes both volatile and non-volatile media and both removable and non-removable media. In addition, the computer-readable medium may include any computer storage medium. The computer storage medium includes volatile and non-volatile media and removable and non-removable media implemented in any method or technology for storing information such as computer-readable instructions, data structures, program modules, or other data.

Although the method and system of the present invention have been described in connection with certain embodiments, some or all of their components or operations may be implemented using a computer system having a general-purpose hardware architecture.

The foregoing description of the present invention is for purposes of illustration, and those skilled in the art to which the present invention pertains will appreciate that various modifications can be made in other specific forms without changing the technical spirit or essential characteristics of the present invention. Therefore, the embodiments described above should be understood as illustrative and not restrictive in all aspects. For example, each component described as being implemented in a single form may be distributedly implemented, and likewise, components described as being distributed may be implemented in a combined form.

The scope of the present invention should be defined by the claims that follow rather than by the foregoing detailed description, and all modifications or variations derived from the meaning, scope, and equivalents of the claims should be interpreted as being included within the scope of the present invention.

### DESCRIPTION OF REFERENCE NUMERALS

10: processing apparatus
100: elementary processing unit
200: line buffer
300: controller

What is claimed is:

1. A processing apparatus for accelerating convolution operations, comprising:
a plurality of elementary processing unit arranged in an array structure;
a line buffer in which data is temporarily stored; and
a controller configured to control operations of the line buffer and the elementary processing unit to perform convolution operations,
wherein the controller stores a portion of feature-map data in the line buffer for the convolution operations and performs convolution operations on a portion of the feature-map data stored in the line buffer and kernel data stored in the elementary processing unit,
and wherein the controller divides a feature map to be processed during the convolution operations into a plurality of partitions in consideration of a storage capacity of the line buffer and a size of the feature map, and stores, in the line buffer, data among the divided feature-map data that is to be operated with the kernel data.

2. The processing apparatus of claim 1,
wherein the controller adjusts a range of feature-map data to be stored in the line buffer according to a stride of the kernel.

3. The processing apparatus of claim 1,
wherein the controller adds, to the line buffer, feature-map data to be newly included in a convolution operation that has not been stored in the line buffer according to a stride of the kernel, includes feature-map data stored in the line buffer in the convolution operation, and deletes a portion of feature-map data to be excluded from the convolution operation from the line buffer.

4. The processing apparatus of claim 1,
wherein the controller calculates, as a width of each partition, a value
$$⌈ \frac{{W}^{i} + 2 ( P - 1 ) ⌊ {kW}^{i} / 2 ⌋}{P} ⌉$$
corresponding to a sum of a value obtained by dividing an entire width W of a feature map by a number of partitions and a term corrected by a kernel width kW.

5. The processing apparatus of claim 1,
wherein the controller determines a capacity of the line buffer according to the following mathematical expression.
$${L}_{i} = ⌈ \frac{{W}^{i} + 2 ( P - 1 ) ⌊ {kW}^{i} / 2 ⌋}{P} ⌉ \cdot ( {kH}^{i} - 1 ) + {kW}^{i} \qquad [ Mathematical Expression ]$$
L: capacity of the line buffer,
W: width of the feature map,
kW: width of the kernel,
kH: height of the kernel,
P: number of partitions,
i: layer.

6. The processing apparatus of claim 1,
wherein the controller performs convolution operations in different phases for respective feature maps divided into a plurality of partitions, and outputs, as a convolution-operation result for the feature map, a result obtained by simply merging convolution-operation results for the respective partitions.

7. The processing apparatus of claim 6,
wherein the controller includes a phase tracker configured to track information on a phase in which a current convolution operation is performed, and a position tracker configured to track a coordinate of the feature map on which the current convolution operation is performed,
wherein the phase tracker outputs an identification number of an adjacent second phase when completion of a convolution operation for a first phase is detected, and
wherein the position tracker outputs a coordinate position within the adjacent second phase when completion of a convolution operation for the first phase is detected.

8. A method of operating a processing apparatus for accelerating convolution operations, comprising:
dividing a feature map on which convolution operations are to be performed into a plurality of partitions;
storing, in a line buffer, data among the divided feature-map data that is to be operated with kernel data; and
performing convolution operations on a portion of feature-map data stored in the line buffer and kernel data stored in elementary processing unit included in the processing apparatus.

9. The method of claim 8,
wherein the dividing of the feature map into the plurality of partitions includes calculating, as a width of each partition, a value
$$⌈ \frac{{W}^{i} + 2 ( P - 1 ) ⌊ {kW}^{i} / 2 ⌋}{P} ⌉$$
corresponding to a sum of a value obtained by dividing an entire width W of the feature map by a number of partitions and a term corrected by a kernel width kW.

10. The method of claim 8,
wherein the performing of the convolution operation includes adjusting a range of feature-map data to be stored in the line buffer according to a stride of the kernel.

11. The method of claim 8,
wherein the performing of the convolution operation includes adding, to the line buffer, feature-map data not stored in the line buffer and to be newly added to an convolution operation target due to a stride of the kernel, adding feature-map data stored in the line buffer to the operation target, and deleting, from the line buffer, a portion of feature-map data to be removed from the operation target.

12. The method of claim 8,
wherein the performing of the convolution operation includes performing convolution operations in different phases for respective feature maps divided into a plurality of partitions, and outputting, as a convolution-operation result for the feature map, a result obtained by simply merging convolution-operation results for the respective partitions.

13. The method of claim 8,
wherein the performing of the convolution operation includes performing a convolution operation for feature-map data of a first partition in a first phase, performing a convolution operation for feature-map data of a second partition in a second phase, and outputting a result obtained by merging the convolution-operation result of the first phase and the convolution-operation result of the second phase.
